(19) United States
(12) Patent Application Publication
(10) Pub. No.: US 2020/0242213 A1
(43) Pub. Date: Jul. 30, 2020

(54) METHOD AND SYSTEM FOR DIGITAL RIGHTS MANAGEMENT

(71) Applicant: BlackBerry Limited, Waterloo (CA)

(72) Inventors: Oren Gad Geva, Petah Tikva (IL); Timothy Choi, Cleveland, OH (US); Nili Davidor, Petah Tikva (IL); Shai Efraim Yitzhaik, Petah Tikva (IL); Gal Kedem, Petah Tikva (IL); Sharon Rozinsky, Petah Tikva (IL)

(21) Appl. No.: 16/259,633

(22) Filed: Jan. 28, 2019

(51) Int. Cl. G06F 21/10; G06F 21/62; H04L 9/08

(52) U.S. Cl. CPC G06F 21/105; H04L 9/0869; G06F 21/6209

(57) ABSTRACT

A method at a computing device for document rights management, the method comprising: receiving, at the computing device, a document; encrypting the document using a content key; creating a header, the header including a document identifier and an identifier for the computing device; persisting permissions for the document at the computing device; and returning a stream comprised the encrypted document and the header.

### FIELD OF THE DISCLOSURE

The present disclosure relates to Digital Rights Management, and in particular relates to Digital Rights Management as a service for any file type.

### BACKGROUND

Digital rights management (DRM) is a digital file control technology which allows the owner of a digital source, such as a document, file, executable, or media, among others, to control what is done with such a digital source. For example, DRM may allow the owner of the digital source to prevent the digital source from being copied, shared, printed, saved, or edited, among other options.

Typically, DRM is implemented in a rigid system in which the source of the digital file, and hence the type of digital file, is well known. In this case, other file types and varied security and auditing policies for the digital files are not possible.

### BRIEF DESCRIPTION OF THE DRAWINGS

The present disclosure will be better understood with reference to the drawings, in which:

FIG. 1 is a block diagram of a system for performing Digital Rights Management;

FIG. 2 is a process diagram at a user agent for protecting a digital source in a DRM system;

FIG. 3 is a dataflow diagram showing processes for protecting documents and use licenses between a user agent and a server;

FIG. 4 is a dataflow diagram showing the sharing of a document, including persisting permissions, between a user agent and server;

FIG. 5 is a dataflow diagram showing the opening of a protected document at a user agent communicating with a server in a DRM system; and

FIG. 6 is a block diagram of an example computing device or server capable of being used with the embodiments of the present disclosure.

### DETAILED DESCRIPTION OF THE DRAWINGS

The present disclosure provides a method at a computing device for document rights management, the method comprising: receiving, at the computing device, a document; encrypting the document using a content key; creating a header, the header including a document identifier and an identifier for the computing device; persisting permissions for the document at the computing device; and returning a stream comprised the encrypted document and the header.

The present disclosure further provides a computing device for document rights management, the computing device comprising: a processor; and a communications subsystem, wherein the computing device is configured to: receive a document; encrypt the document using a content key; create a header, the header including a document identifier and an identifier for the computing device; persist permissions for the document at the computing device; and return a stream comprised the encrypted document and the header.

The present disclosure further provides a computer readable storage medium for storing instruction code for document rights management, which, when executed by a processor of a receive a document; encrypt the document using a content key; create a header, the header including a document identifier and an identifier for the computing device; persist permissions for the document at the computing device; and return a stream comprised the encrypted document and the header.

In accordance with the embodiments of the present disclosure, methods and systems are provided to protect and store permissions for any file type. In various embodiments, third party applications may be used to securely retrieve a user's license details, decrypt the files for consumption, and enforce DRM limitations.

A protected file, once created, may be opened by a client that is aware of the DRM processes. The client may query servers regarding a user's license and allow such user to open the file, while allowing or preventing actions such as saving, editing, copying, printing, among other options, depending on the DRM settings for that file.

In particular, in the embodiments provided, server-side components may be used to encrypt files and store permission data. The server side may also track actions and keep audit logs for DRM actions.

In some cases, the server may have an application program interface (API) to securely retrieve rights management actions.

A client may be provided on a computing device intending to consume protected digital files. Such client may be created by the provider of the DRM services, or software development kits (SDKs) may be created to allow application or software creators or other third parties to create a client for their particular application.

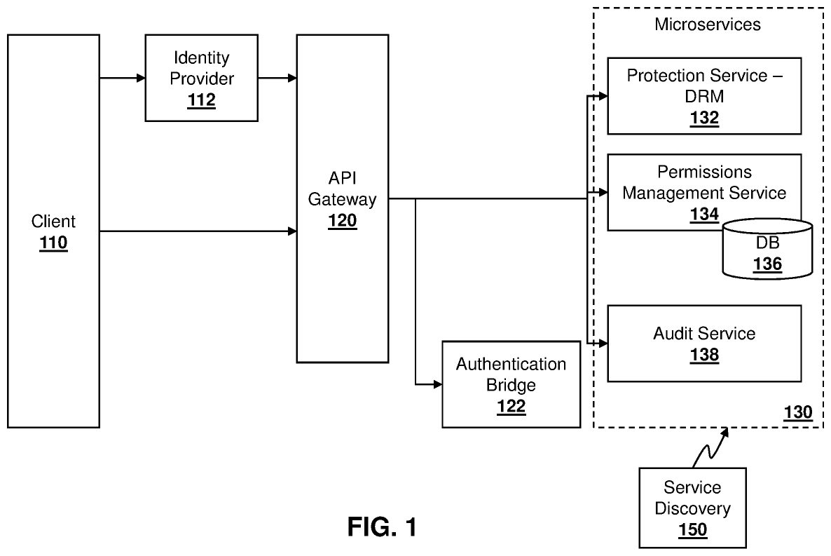

Reference is now made to FIG. 1, which shows an example system for providing an DRM system capable of being used with the embodiments of the present disclosure. In particular, in the embodiment of FIG. 1, a client 110 may be found on a user device. The client 110 may be a viewer application that may be built by the provider of the DRM services, or may be custom built by third parties utilizing an SDK, among other options.

Client 110 may communicate with an identity provider 112. Identity provider 112 is any system with which the client can authenticate and obtain an access token to issue API calls. For example, the token can be an electronic Identifier (eID) or any external Identity Provider (IdP) that is supported by the system.

A client 110 may communicate with an API gateway 120, for example utilizing a token obtained from identity provider 112. API gateway 120 is a common service in a micro-services architecture in charge of API routing, request and response monitoring, among other functionality. For example, the requests or responses may use HyperText Transfer Protocol (HTTP) in some cases. However, other protocols could be equal utilized.

In some cases, the API gateway 120 may communicate with an authentication bridge 122. Authentication bridge 122 is a service that may be part of API gateway 120 and that is in charge of parsing API token access.

The API gateway 120 may be configured to access a plurality of micro-services 130. For example, in the embodiment of FIG. 1, one example of micro-services 130 includes a protection service 132. Protection service 132 is a service in charge of performing a document sealing. In particular, protection service 132 will implement any supported file type that a DRM layer is to be added to. The main function of protection service 132 is to accept a document and return it in a sealed manner, with a DRM layer.

A further micro-service in the embodiment of FIG. 1 is a permissions management service 134. Permissions management service 134 is a service responsible for setting document permissions. It persists the permissions per client per document, and is also able to retrieve permissions in a use license form. The use license is the information required by the client application to decide if a certain user can access a certain document and in accordance with which permissions.

In particular, the document permissions may be persisted in a database 136 in the embodiment of FIG. 1. However, in other embodiments, database 136 may be remote from the permissions management service 134.

A further micro-service in the embodiment of FIG. 1 is the audit service 138. The audit service 138 is responsible for tracking the activity in the system. Any action can be registered in the audit service and later exported for a customer to see. The exported data can be gathered as different types of reports.

Further, a service discovery function 150 is a logical action responsible for identifying the different services in the system. Service discovery function 150 is a common component in the micro-services based system of FIG. 1.

Based on the embodiment of FIG. 1, a document creator or owner can protect the document using DRM. Other users may then access, edit, print, or perform other functionality on the document based on the permissions set and persisted for the document.

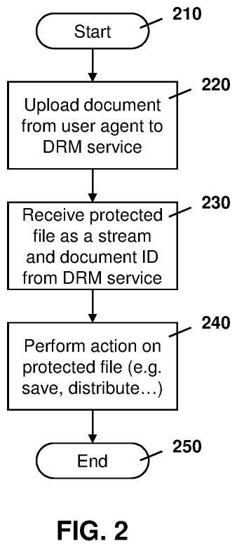

In particular, reference is now made to FIG. 2 which shows a process at a client or user agent for protecting a document. The process of FIG. 2 starts at block 210 and proceeds to block 220 in which a user agent is used to upload a document to the DRM service, such as the service of FIG. 1.

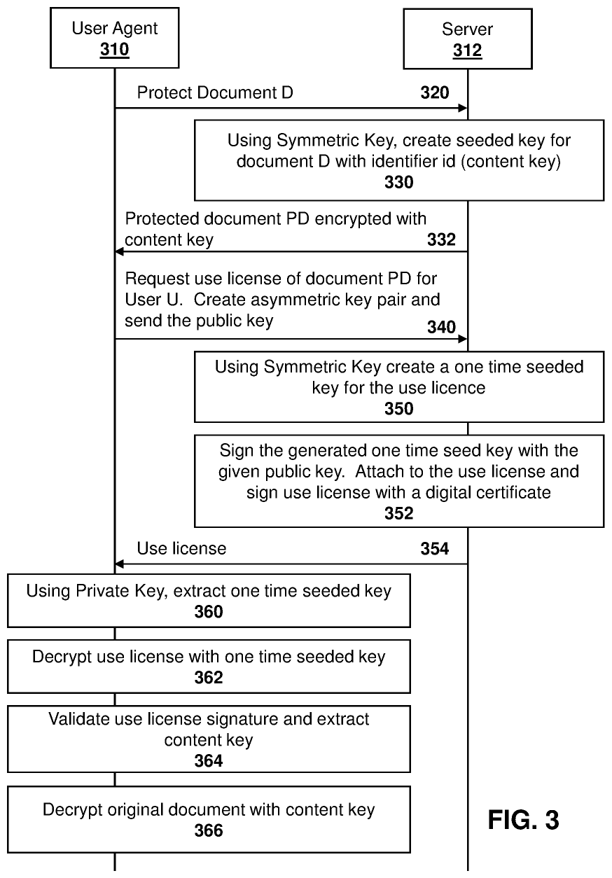

Once the document is uploaded to the DRM service, the DRM service may then protect the file and return the file to the user in the form of the stream with a document identifier. This is shown, for example, at block 230. The protection of the document is provided below with regards to FIG. 3.

From block 230, the process proceeds to block 240 in which the user agent may decide what to do with the protected file. For example, the user agent may save the protected file in storage, distribute the protected file to another application for consumption, among other options. The saving may be accomplished by a services type call which may be able to move the file into any storage environment, including but not limited to cloud storage services, managed file transfer, third party applications, among others. A document identifier may be then saved by the user agent.

From block 240, the process proceeds to block 250 and ends.

The creation of the stream containing the protected file and header may be done, for example, in accordance with the embodiment of FIG. 3.

In particular, in the embodiment of FIG. 3, user agent 310 communicates with server 312. As seen at message 320, the user agent 310 may send a document “D” to the server 312.

The server 312 may use a symmetric key in order to create a seeded key for the document D, along with an identifier ID. The seeded key may be considered to be a content key for the document. The creation of the content key is shown, for example, at block 330 of FIG. 3.

The server 312 may then return the protected document “PD” to the user agent 310 in message 332. The protected document is returned in the form of a stream with the protected, encrypted document, along with a header containing the documents identifier. The steam may further contain a link to the server 312, for example in the form of a Uniform Resource Identifier.

As indicated above, the user agent 310 may then decide what to do with the document, including storing the document, distributing the document to an application, among other functionality.

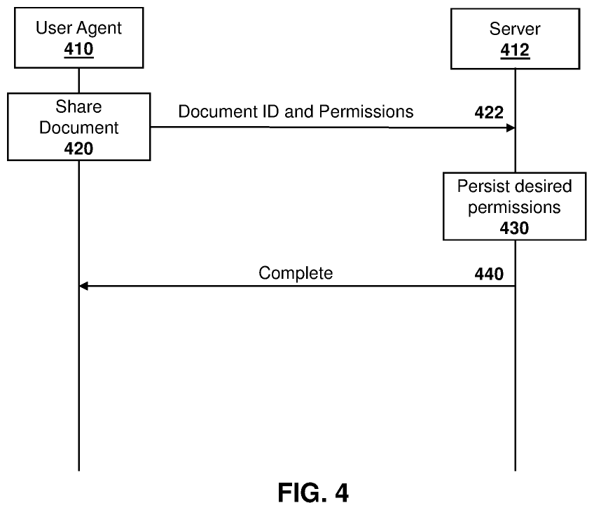

In some cases, a user may then wish to share a protected document with others. Reference is now made to FIG. 4. In the embodiment of FIG. 4, user agent 410 communicates with a server 412. The user agent 410 and server 412 may be the same as user agent 310 and server 312 of FIG. 3.

In the embodiment of FIG. 4, a user decides to share a document, shown at block 420. In this regard, the user agent notifies the server 412 by providing a document identifier and the permissions for the document, as shown by message 422. The permissions for the document may be customized based on document type. Thus, permissions for what can be done with a text file may be different than permissions for what can be done with an audio file, an executable file, or some other file type.

A server 412 may then perform a verification for the user agent (not shown) and then persist the desired permissions for the document as shown at block 430.

In some embodiments, a message 440 may be sent back to user agent 410 to indicate that the document permissions have been persisted.

Further, at some point, a user may wish to open the protected document. In this case, the user may be the original creator of the document or may be a user to whom the original creator provided permissions.

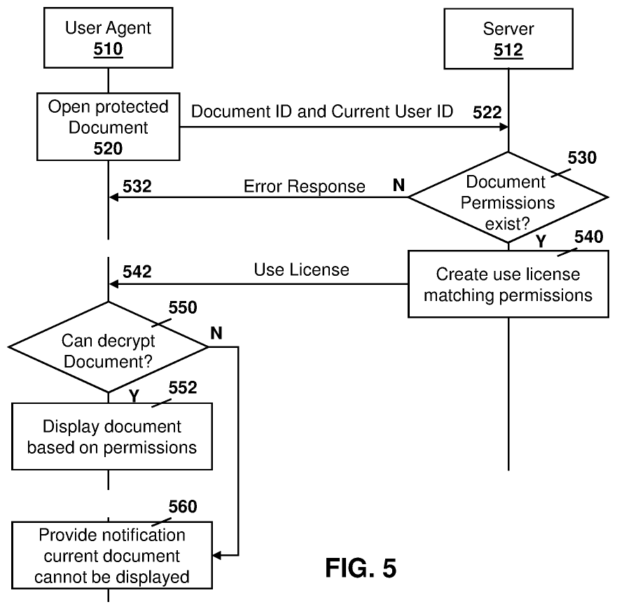

Reference is now made to FIG. 5. In the embodiment of FIG. 5, a user agent 510 communicates with a server 512. User agent 510 may be the same as user agent 310 or user agent 410 in some cases. Further, server 512 may be the same as server 312 or server 412 in some cases.

A user wishes to open a protected document, as shown at block 520. In this case, the user agent may send the document ID and the current user ID, shown with message 522, to server 512.

At server 512, message 522 is received and a check may be performed at block 530 to determine whether the document permissions exist. For example, a check is made within a database to determine whether the document ID exists within such database for persisted permissions. If not, then an error message 532 may be provided back to user agent 510 indicating that the document should first be shared.

Conversely, if the document permissions do exist, as determined at block 530, then the server 512 may create a use license matching the persisted permissions, as shown at block 530.

The server 512 may then provide the use license back to user agent 510, as shown by message 542.

At the user agent 510, a check may be made at block 550 to determine whether the document can be decrypted based on the use license. If yes, then the process at the user agent may proceed to block 552 in which of the document is displayed and use of the document is restricted based on the permissions in the use license.

Conversely, if that the document cannot be decrypted at block 550, then the process at the user agent 510 proceeds to block 560 in which a notification is provided that the current document cannot be displayed.

Reference is again made to FIG. 3, which shows various cryptography operations based on the embodiment of FIG. 5. In particular, the request of the use license is shown with message 340. Message 340 includes an identifier for the document and an identifier for a user. For example, the identifier for the user may be a token as received from an identity provider 112 in the embodiment of FIG. 1.

Further, the user agent 310 may create an asymmetric key pair consisting of a public and private key. Message 340 may include the public key for the created key pair.

Server 312 receives message at 340 and then may use a symmetric key known at the server to create a one-time seeded key for a use license, as shown at block 350.

At block 352 the server may then sign the generated one-time seeded key with that the given public key. It may further attach the use license and sign the use license with a digital certificate stored at server 312. For example, the digital certificate may be from a trusted certificate authority in some cases.

The server 312 may then send a message 354 to user agent 310 containing the use license as generated and signed at blocks 350 and 352.

User agent 310 may, using the private key from the key pair that was previously generated, extract the one time seeded the key at block 360.

Once the seeded key is extracted, it may then be used to decrypt the use license as shown at block 362.

The extracted use license may then be validated at block 364. Particular, the signature used with the use license may be verified. Once verified, the content key may be extracted from the use license.

Once the content key is extracted, it may be used to decrypt the original document as shown at block 366.

The user agent may then control the permitted uses of the document based on the use license. In particular, the user agent may only allow the document to be shared with an application that includes rights management layers to control use of the digital document or file. For example, as indicated above, such rights management may include preventing a user from saving an unencrypted document, from sharing the document with others, from printing the document, from editing the document, from playing a file, from extracting documents, from executing certain documents, among other options. In some cases, time limits may be included with the documents indicating how long a user agent is allowed to access the document before the document must be deleted. Other use permissions are possible.

As will be appreciated by those in the art, the use license may be customized for each digital source type and may be implemented based on the provider of the DRM service or the third-party client developer. For example, a text document may allow restrictions on the editing of the document, the printing of the document, the saving or sharing of the document, among other options. Conversely, a compressed file may allow for restrictions on the extraction of documents within the compressed file, restrictions on the compression of documents, along with the sharing of the compressed file, among other options. A music or video document may provide restrictions on the number of times the file may be played at a user computing device, along with sharing or copying permissions, among other options. In this case, the type of use permissions capable of being configured may be enumerated when the file type is being added to the DRM service.

Based on FIGS. 1 to 5 above, a DRM service is provided in which any file type may be configured within the DRM service. In each case, a digital source may be provided to a server, which may encrypt the source and provide a stream with a header back to the user agents. The header would, in the embodiments described herein, contain at least an identifier for the document which would uniquely identify the document at the server. For example, the identifier may be a Universal Unique Identifier (UUID).

In some cases, the header may contain an identifier for the server which is used to persist the permissions for the document. For example, the header may contain an embedded Universal Resource Indicator (URI) for such server. However, other identifiers besides a URI may be provided.

A client at the user side may query the server regarding the user's license, and allow them to open the digital source in accordance with the license, thereby allowing or preventing actions with the digital source.

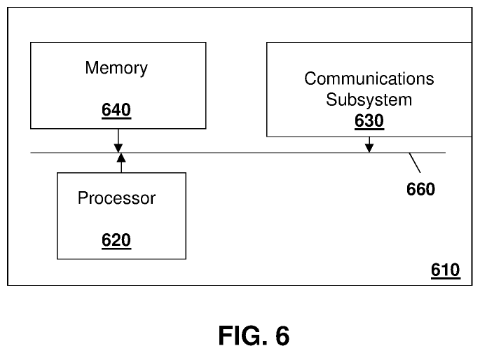

A server or user agent performing the embodiments of FIGS. 1 to 5 may be any computing device, network node or element, or may be a combination of computing devices, network nodes or elements. For example, one simplified server that may perform the embodiments described above is provided with regards to FIG. 6.

In FIG. 6, server 610 includes a processor 620 and a communications subsystem 630, where the processor 620 and communications subsystem 630 cooperate to perform the methods of the embodiments described herein.

The processor 620 is configured to execute programmable logic, which may be stored, along with data, on the server 610, and is shown in the example of FIG. 6 as memory 640. The memory 640 can be any tangible, non-transitory computer readable storage medium, such as DRAM, Flash, optical (e.g., CD, DVD, etc.), magnetic (e.g., tape), flash drive, hard drive, or other memory known in the art. In one embodiment, processor 620 may also be implemented entirely in hardware and not require any stored program to execute logic functions.

Alternatively, or in addition to the memory 640, the server 610 may access data or programmable logic from an external storage medium, for example through the communications subsystem 630.

The communications subsystem 630 allows the server 610 to communicate with other devices or network elements.

Communications between the various elements of the server 610 may be through an internal bus 660 in one embodiment. However, other forms of communication are possible.

The embodiments described herein are examples of structures, systems or methods having elements corresponding to elements of the techniques of this application. This written description may enable those skilled in the art to make and use embodiments having alternative elements that likewise correspond to the elements of the techniques of this application. The intended scope of the techniques of this application thus includes other structures, systems or methods that do not differ from the techniques of this application as described herein, and further includes other structures, systems or methods with insubstantial differences from the techniques of this application as described herein.

While operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be employed. Moreover, the separation of various system components in the implementation descried above should not be understood as requiring such separation in all implementations, and it should be understood that the described program components and systems can generally be integrated together in a signal software product or packaged into multiple software products. In some cases, functions may be performed entirely in hardware and such a solution may be the functional equivalent of a software solution.

Also, techniques, systems, subsystems, and methods described and illustrated in the various implementations as discrete or separate may be combined or integrated with other systems, modules, techniques, or methods. Other items shown or discussed as coupled or directly coupled or communicating with each other may be indirectly coupled or communicating through some interface, device, or intermediate component, whether electrically, mechanically, or otherwise. Other examples of changes, substitutions, and alterations are ascertainable by one skilled in the art and may be made.

While the above detailed description has shown, described, and pointed out the fundamental novel features of the disclosure as applied to various implementations, it will be understood that various omissions, substitutions, and changes in the form and details of the system illustrated may be made by those skilled in the art. In addition, the order of method steps is not implied by the order they appear in the claims.

When messages are sent to/from an electronic device, such operations may not be immediate or from the server directly. They may be synchronously or asynchronously delivered, from a server or other computing system infrastructure supporting the devices/methods/systems described herein. The foregoing steps may include, in whole or in part, synchronous/asynchronous communications to/from the device/infrastructure. Moreover, communication from the electronic device may be to one or more endpoints on a network. These endpoints may be serviced by a server, a distributed computing system, a stream processor, etc. Content Delivery Networks (CDNs) may also provide communication to an electronic device. For example, rather than a typical server response, the server may also provision or indicate data for a content delivery network (CDN) to await download by the electronic device at a later time, such as a subsequent activity of electronic device. Thus, data may be sent directly from the server, or other infrastructure, such as a distributed infrastructure, or a CDN, as part of or separate from the system.

Typically, storage mediums can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method at a computing device for document rights management, the method comprising:
receiving, at the computing device, a document;
encrypting the document using a content key;
creating a header, the header including a document identifier and an identifier for the computing device;
persisting permissions for the document at the computing device; and
returning a stream comprised the encrypted document and the header.

2. The method of claim 1, wherein the content key comprises a seeded key created from a symmetric key at the computing device.

3. The method of claim 1, wherein the persisting permissions comprises receiving permissions at the computing device for the document and storing the permissions in a database associated with the computing device.

4. The method of claim 3, wherein the receiving permissions includes receiving a message containing the document identifier and the permissions.

5. The method of claim 4, wherein the permissions are customized based on a document type for the encrypted document.

6. The method of claim 1, further comprising:
receiving, at the computing device, a request for a use license for the encrypted document;
determining that the document includes persisted permissions;
creating a use license matching the persisted permissions; and
returning the use license.

7. The method of claim 6, wherein the use license is created using a one-time seeded key used to decrypt the encrypted document.

8. The method of claim 7, wherein the request for the use license includes a public key, and wherein the returning the use license includes encrypting the one-time seeded key with the public key.

9. The method of claim 1, wherein the receiving is from an Application Program Interface gateway.

10. A computing device for document rights management, the computing device comprising:
a processor; and
a communications subsystem,
wherein the computing device is configured to:
receive a document;
encrypt the document using a content key;
create a header, the header including a document identifier and an identifier for the computing device;
persist permissions for the document at the computing device; and
return a stream comprised the encrypted document and the header.

11. The computing device of claim 10, wherein the content key comprises a seeded key created from a symmetric key at the computing device.

12. The computing device of claim 10, wherein the persisting permissions comprises receiving permissions at the computing device for the document and storing the permissions in a database associated with the computing device.

13. The computing device of claim 12, wherein the computing device is configured to receive permissions by receiving a message containing the document identifier and the permissions.

14. The computing device of claim 13, wherein the permissions are customized based on a document type for the encrypted document.

15. The computing device of claim 10, wherein the computing device is further configured to:
receive a request for a use license for the encrypted document;
determine that the document includes persisted permissions;
create a use license matching the persisted permissions; and
return the use license.

16. The computing device of claim 15, wherein the use license is created using a one-time seeded key used to decrypt the encrypted document.

17. The computing device of claim 16, wherein the request for the use license includes a public key, and wherein the returning the use license includes encrypting the one-time seeded key with the public key.

18. The computing device of claim 10, wherein the computing device is configured to receive from an Application Program Interface gateway.

19. A computer readable storage medium for storing instruction code for document rights management, which, when executed by a processor of a
receive a document;
encrypt the document using a content key;
create a header, the header including a document identifier and an identifier for the computing device;
persist permissions for the document at the computing device; and
return a stream comprised the encrypted document and the header.
